(19) United States
(12) Patent Application Publication
(10) Pub. No.: US 2008/0133721 A1
(43) Pub. Date: Jun. 5, 2008

(54) Method For Installing An Automation Component And Correspoding Automation System

(75) Inventors: Mirko Danz, Feucht (DE); Johannes Extra, Erlangen (DE); Peter Wagner, Hersbruck (DE)

Correspondence Address: HENRY M FEIEREISEN, LLC, 350 FIFTH AVENUE, SUITE 4714, NEW YORK, NY, 10118, US

(73) Assignee: Siemens Aktiengesellschaft, Munchen (DE)

(21) Appl. No.: 10/597,959

(22) PCT Filed: Jan. 28, 2005
(86) PCT No.: PCT/EP05/50369

§ 371 Date: Nov. 19, 2007

(30) Foreign Application Priority Data
Feb. 13, 2004 (DE) 10 2004 007 233.7

(51) Int. Cl. G06F 15/177

(52) U.S. Cl. 709/222

(57) ABSTRACT

The aim of the invention is to provide a method according to which an automation component is automatically integrated into a communication network. For this purpose, the automation component automatically requests a communication address during log-on (S1). A server present in the communication network transmits a corresponding communication address to the requesting automation component or to the client (S2). The inventive method eliminates the need for manually assigning a communication address for an automation component.

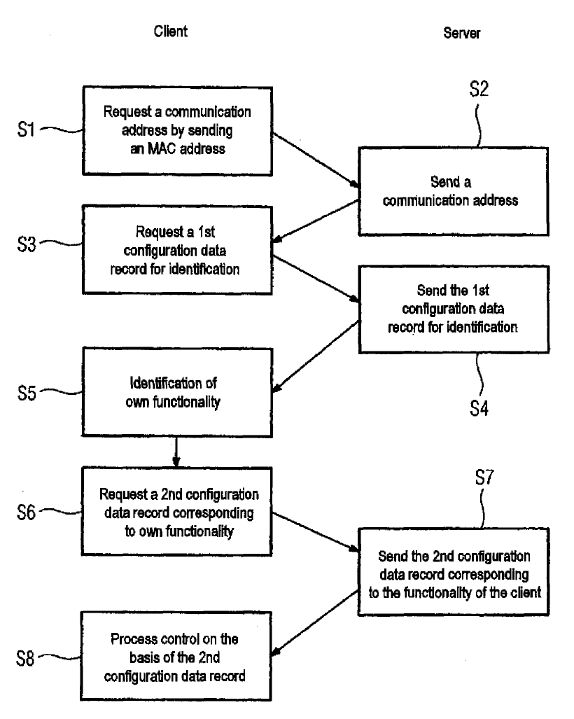

The present invention relates to a method for installation of an automation component in an automation system. The present invention also relates to a corresponding automation system having an automation component to be installed and having a server for provision of data for the automation system.

Complex manufacturing appliances are typically controlled by means of automation appliances and components. The manufacturing appliances are often in a modular form, and each module has an associated automation appliance. The automation appliances are interconnected with the aid of a communication network in order to form an automation system. By way of example, one automation appliance is used as a server, and the others are used as clients, within the communication network.

It may be necessary to set up a machine or a manufacturing appliance from new, to convert it for a different purpose, or to rectify a defect in the manufacturing appliance. In any case, one of the modules must normally be replaced, or a new module must be added to the manufacturing appliance, for this purpose. When the new module is connected, its automation appliance must be configured in accordance with the functionality of the module.

In order that the component to be newly installed can actively participate in the communication network of the automation system, the component or the module must be assigned a communication address. As is known, in situations such as these, the communication address is allocated manually, with the assistance of an engineering system. This type of address allocation is, however, complex and susceptible to errors.

The object of the present invention is thus to make it easier to connect an automation appliance to a communication network for an automation system.

According to the invention, this object is achieved by a method for installation of an automation component in an automation system by request for a communication address by the automation component, reception of a communication address from a server for the automation system by the automation component, and activation of the communication address by the automation component.

Furthermore, the invention provides for an automation system having an automation component to be installed and having a server for provision of data for the automation system, in which the automation component to be installed can automatically request and activate a communication address, and the data provided by the server comprises a communication address.

The installation process is preferably designed in such a way that it is compatible with the timing of the communication protocol in the automation system. This ensures that the automation component is included in the communication network of the automation system without interfering with ongoing communication with other automation components.

The server may be a DHCP/Nameserver and the communication address may be a dynamic DP slave address or IP address. The methods used in conjunction with DHCP, BootP etc. can thus be used for allocation of communication addresses for the automatic activation of an automation component.

It is also advantageous for the automation component to send an MAC address in order to request a communication address. This unique hardware address can then be assigned a likewise unique communication address at least for as long as the corresponding component is integrated in the communication network.

The present invention will now be explained in more detail with reference to the attached drawing, which shows a flowchart of a method according to the invention.

The exemplary embodiment described in more detail in the following text represents one preferred embodiment of the present invention.

When an automation component is coupled to an automation system or communication network, the automation component checks whether it already has a communication address. When it is first coupled to the communication network, the automation component will not yet have a communication address. The automation component or the client thus requests a communication address from the server in the communication network, as in step 1 in the FIGURE. This is done, for example, by the client sending a unique hardware address, for example an MAC address, to the communication network. According to step 2, the server then sends a communication address which has not yet been allocated, to the client. If the server is a DHCP/Nameserver, then the client receives an IP address.

The client then checks whether it has a configuration which allows identification of its functionality. This functionality includes the location or plug-in slot of the client on the machine, the type of automation appliance, the specific functionality of the automation appliance, etc. If the client does not have a configuration or a configuration data record for identification of functionality, it requests the loading of such an initial configuration, as in step S3 in the FIGURE, by the system service from the central server. The initial configuration can be defined by the user himself.

In a step S4, the server sends the initial configuration or a first configuration data record for identification to the requested client. As soon as the client has received this first configuration data record, he will activate it. This allows the functionality to be identified in the user program of the client (see step S5). The operator or user can implement his own methods for identification of the functionality.

After the identification of own functionality, the client uses this identification to request the configuration associated with it, that is to say a second configuration data record, from the server in step S6. In step S7, the server then loads the second configuration data record requested by the client into an appropriately provided memory medium for the client. In this case, appropriate firmware versions, a required technological packet, an appropriate project (terminology of automation engineering) can also be loaded from the server into the client.

During this process, the client is always the active part. It is that component which requests the required configuration from the server. The client also has the intelligence for selection of the configuration. The server represents only a file server for different configurations. This means that, in the end, the client itself selects the configurations or configuration data records stored in it.

The client may already have a further configuration data record (not illustrated in the FIGURE). The client can thus select the second and further configuration data records. In this case, the client decides which of the two data records is the more up to date. In the present example, the second configuration data record is the more up to date, so that the client activates this data record. As in step S8, the client then carries out its process in accordance with the second configuration data record.

The client or the automation component is designed such that the requesting S1 and sending S2 of a communication address take place using the timing of the communication protocol. In consequence, there is no need to interrupt the communication in the communication network when connecting the new automation component, or to significantly adversely affect it. The same applies to the rest of the configuration process for the client: this is also carried out using the timing of the communication protocol.

In summary, it can be stated that the steps mentioned above allow automatic configuration of a “neutral automation appliance” which does not yet have a communication address. The allocation of a communication address is the precondition for subsequent loading of a configuration from a configuration server, as has likewise been explained in the above example.

1.-8. (canceled)

9. A method for installation of an automation component in an automation system, comprising the steps of:
a) request of a communication address by the automation component;
b) sending a communication address to the automation component from a server of an automation system in response to the request by the automation component; and
c) activating the communication address from the server by the automation component after reception of the communication address.

10. The method of claim 9, wherein the steps a)-c) are compatible with a timing of a communication protocol in the automation system to enable reception of the automation component in the automation system without interfering with an ongoing communication with other automation components.

11. The method of claim 9, wherein the server is a DHCP/Nameserver and the communication address is an IP address.

12. The method of claim 9, wherein the step a) includes the step of having the automation component send an MAC address in order to request the communication address.

13. An automation system, comprising:
a plurality of automation components; and
a server including data which comprises a communication address for an automation system to be installed, said automation component automatically requesting the communication address from the server and being activated in response to a reception of the communication address.

14. The automation system of claim 13, wherein installation of the automation component in the automation system is effected in conformity to a timing of a communication protocol.

15. The automation system of claim 13, wherein the server is a DHCP/Nameserver, and the communication address is an IP address.

16. The automation system of claim 15, wherein the automation component to be installed sends an MAC address in order to request a communication address.
